(19) United States
(12) Patent Application Publication
(10) Pub. No.: US 2010/0272970 A1
(43) Pub. Date: Oct. 28, 2010

(54) FIBER MATERIAL COMPONENT WITH 3D SURFACE AND METHOD OF MANUFACTURING THE SAME

(75) Inventor: CHUN-YUAN CHANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng,Taipei Hsien (TW)

(21) Appl. No.: 12/503,969

(22) Filed: Jul. 16, 2009

(30) Foreign Application Priority Data
Apr. 28, 2009 (CN) 200910301916.X

(51) Int. Cl. B32B 3/10; B32B 9/00; B29C 43/02

(52) U.S. Cl. 428/203; 428/408; 428/332; 428/195.1; 264/319

(57) ABSTRACT

A method is provided for manufacturing a fiber material component with a 3D surface. A plurality of interwoven carbon fibers is provided and shaped according to the 3D surface of the carbon fiber material component. A film comprising patterns and characters is adhered to the 3D surface of the fiber material component. A fiber material component with a 3D surface is provided as well.

### BACKGROUND

1. Technical Field

The disclosure relates to fiber material components with three-dimensional (3D) surfaces and a method of manufacturing the same.

2. Description of Related Art

It is difficult to paint different patterns or characters on carbon fiber materials, and consequently, electronic device enclosures having 3D surfaces made from carbon fibers are plain and unattractive.

### BRIEF DESCRIPTION OF THE DRAWINGS

FIG. 1 is a flowchart of an embodiment of a method for manufacturing a fiber material component.

FIG. 2 is a flowchart of another embodiment of a method for manufacturing a fiber material component.

FIG. 3 is a cross-sectional view of a fiber material component.

FIG. 4 is a cross-sectional view of another embodiment of a fiber material component.

### DETAILED DESCRIPTION

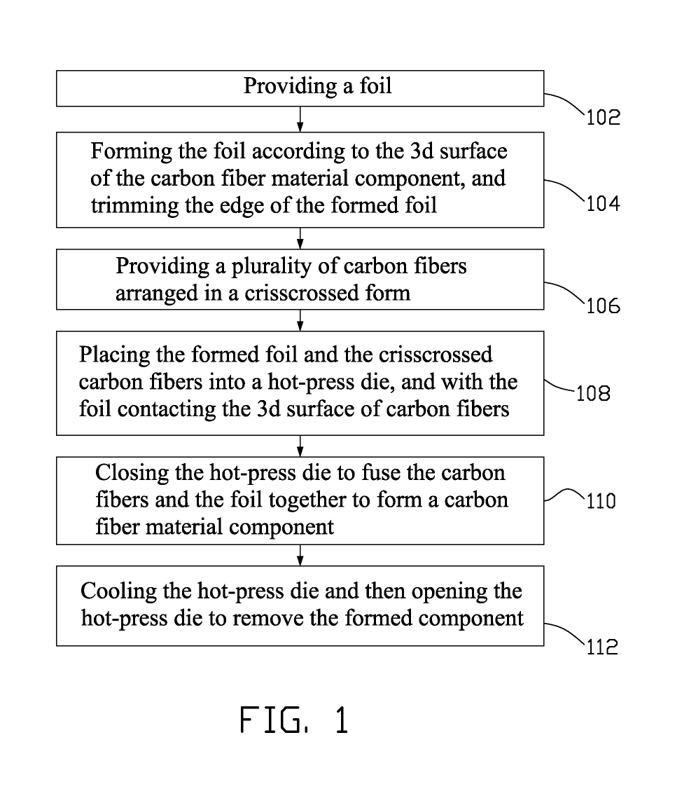

Referring to FIG. 1, an embodiment of a method is utilized to manufacture a carbon fiber material component having a 3D surface decorated with patterns and/or symbols such as characters. The method includes the following steps.
Step 102, a film is provided to attached to the 3D surface of the carbon fiber material component. The film includes the with patterns and characters printed thereon.
Step 104, the film is shaped in a first mold to curvilinear according to the designed 3D surface of the carbon fiber material component. An edge of a formed film is trimmed according to an edge of the carbon fiber material component.
Step 106, a plurality of interwoven carbon fibers is provided layer upon layer and shaped in a second mold according to the designed 3D surface of the carbon fiber material component. The number of the carbon fibers corresponds to final thickness of the carbon fiber material component to be formed.
Step 108, the formed film and the crisscrossed carbon fibers are placed into a hot-press die. The film contacts the 3D surface of carbon fibers.
Step 110, the hot-press die is closed to fuse the interwoven carbon fibers and the film together to form the carbon fiber material component.
Step 112, the carbon fiber material component is cooled. Then the hot-press die is opened to remove the final carbon fiber component, which is now fabricated with the patterns and symbols.

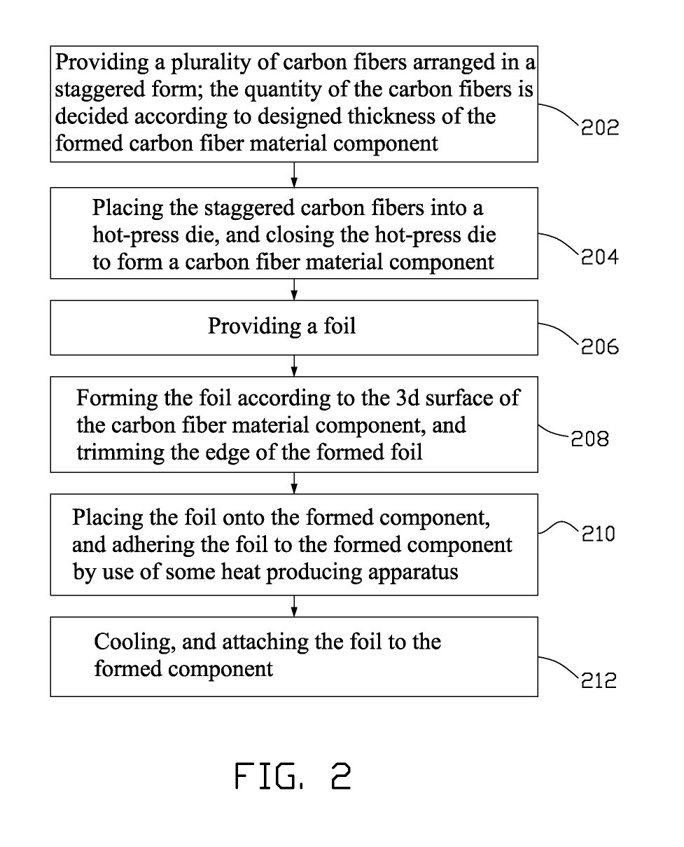

Referring to FIG. 2, another embodiment of a method for manufacturing a carbon fiber material component with patterns or characters thereon, includes the following steps.
Step 202, a plurality of carbon fibers is provided and arranged in a staggered form. The number of the carbon fibers accords to designed thickness of the formed carbon fiber material component.
Step 204, the staggered carbon fibers are placed into a hot-press die to shape the carbon fibers according to the designed 3D surface of the carbon fiber material component. Then the hot-press die is closed to form a carbon fiber body.
Step 206, a film is provided with patterns and characters.
Step 208, the film is shaped in the first mold according to the designed 3D surface of the carbon fiber material component. An edge of a formed film is trimmed according to an edge of the carbon fiber material component.
Step 210, the film is placed on the designed 3D surface of the formed carbon fiber body. The film is adhered to the formed carbon fiber body by heating apparatus, such as an iron.
Step 212, the carbon fiber body is cooled. Then the carbon fiber body is decorated with the patterns and characters and the carbon fiber material component is formed.

The method of the disclosure can be used to form enclosures of different devices, such as notebook computers, mobile phones, for example, which have different patterns and characters thereon.

The method also can use glass fibers to form a fiberglass material component, or other similar fibers.

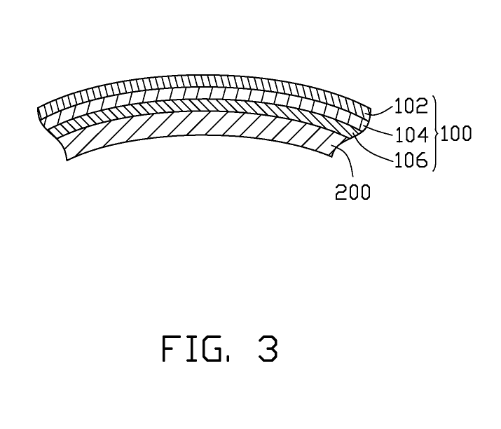

Referring to FIG. 3, the formed fibers component includes a film 100 and a fibers plate 200. The film 100 is attached to the 3D surface of the fibers plate 200. The film 100 includes a base layer 102 away from the fibers plate 200, a pattern layer 104 having different patterns and characters thereon, and an attaching layer 106 attaching the film 100 to the fibers plate 200.

The base layer 102 is used for protecting the formed fibers component from nicking or wearing. The base layer 102 is generally made of one or more of polycarbonate (PC), polyethylene terephthalate (PET), acrylic (PMMA), oriented polypropylene (OPP) and polyvinyl chloride (PVC), for example. Preferably, the thickness of the base layer 102 may range from 0.005 millimeters to 0.5 millimeters.

The pattern layer 104 is provided by printing ink on the base layer 102. A metal decoration layer can also be provided as the pattern layer 104 via plating aluminium, chromium, copper, nickel, indium, and stannum, alone or combined, on the base layer 102 via vacuum evaporation method or electroplating method.

The attaching layer 106 is used for attaching the film 100 to the fiber plate 200. The attaching layer 106 may be made from materials selected from the group consisting of acrylic resin, nitrification fiber resin, polyamine formate resin, chlorination rubber resin, vinyl chloride-co-vinyl-acetic ester copolymer resin, polyamide resin, polyester resin, epoxy resin, polycarbonate resin, olefin resin, and acrylonitrile-butylene-styrene monomer resin, for example. Preferably, the thickness of the attaching layer 106 may range from 0.005 millimeters to 0.5 millimeters. The attaching layer 106 is generally provided via concaved printing, screen printing, offset printing, spraying method, dip coating method, coating in reverse order method, and so on.

The base layer 102 may be transparent or translucent to view the patterns or colors of the pattern layer 104.

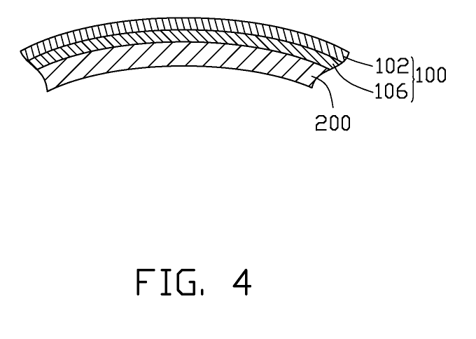

Referring to FIG. 4, furthermore, the film 100 includes a base layer 102 and an attaching layer 106, but does not includes a pattern layer 104 for view the natural color of the fiber plate 200 via the transparent or translucent base layer 102. It may be understood that the base layer 102 may be made of material with color, for coloring the formed fibers component.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A method for forming a fiber material component with a three-dimensional (3D) surface, comprising:
providing a film comprising patterns and characters;
shaping the film according to the 3D surface of the carbon fiber material component, and trimming edges of the formed film;
providing a plurality of interwoven carbon fibers and shaping the carbon fibers according to the designed 3D surface of the carbon fiber material component;
placing the formed film and the carbon fibers into a hot-press die, with the film contacting the 3D surface of carbon fibers;
closing the hot-press die to fuse the interwoven carbon fibers together and the film together to form the fiber material component; and
cooling the carbon fiber material component and then opening the hot-press die to remove the fiber material component.

2. The method of claim 1, wherein the number of the carbon fibers accords to a designed thickness of the carbon fiber material component to be formed.

3. The method of claim 1, wherein the film comprises a base layer, an attaching layer, and a pattern layer having the patterns and characters thereon and located between the base layer and the attaching layer.

4. The method of claim 3, wherein the thickness of the base layer ranges from 0.005 millimeters to 0.5 millimeters.

5. The method of claim 3, wherein the thickness of the attaching layer ranges from 0.005 millimeters to 0.5 millimeters.

6. The method of claim 3, wherein the base layer is transparent or translucent to view the pattern or color of the pattern layer.

7. The method of claim 1, wherein the film comprises a base layer and an attaching layer, the base layer is transparent or translucent for viewing the natural color of the carbon fibers.

8. The method of claim 7, wherein the base layer is made of materials with colors, for coloring the formed fibers component.

9. A method for manufacturing a fiber material component with a 3D surface, comprising:
providing a plurality of carbon fibers arranged in a staggered form; the number of the carbon fibers accords to designed thickness of the carbon fiber material component;
placing the staggered carbon fibers into a hot-press die to shape the carbon fibers according to the designed 3D surface of the carbon fiber material component; and closing the hot-press die to form a carbon fiber body;
providing a film with patterns and characters;
forming the film according to the designed 3D surface of the carbon fiber material component, and trimming edges of the formed film;
placing the film on the formed carbon fiber body, and adhering the film to the formed carbon fiber body by some heating apparatus; and
cooling, and the carbon fiber body being decorated with the patterns and characters and the carbon fiber material component is formed.

10. The method of claim 9, wherein the number of the carbon fibers accords to designed thickness of the carbon fiber material component to be formed.

11. A fiber material component with a 3D surface, comprising:
a fiber plate; and
a film attached on the fiber plate, the film comprising a base layer, and an attaching layer arranged between the base layer and the fiber plate for adhering the film to the fiber plate.

12. The fiber material component of claim 11, wherein the thickness of the base layer ranges from 0.005 millimeters to 0.5 millimeters.

13. The fiber material component of claim 11, wherein the thickness of the attaching layer ranges from 0.005 millimeters to 0.5 millimeters.

14. The fiber material component of claim 11, wherein the base layer is transparent or translucent for viewing the natural color of the fiber plate.

15. The fiber material component of claim 11, wherein the film further comprises a pattern layer having patterns and characters thereon and arranged between the base layer and the attaching layer.

16. The fiber material component of claim 15, wherein the base layer is transparent or translucent to view the pattern or color of the pattern layer.
